(19) United States
(12) Patent Application Publication
(10) Pub. No.: US 2011/0226354 A1
(43) Pub. Date: Sep. 22, 2011

(54) Flow Controller

(76) Inventor: Petur Thordarson, Oceanside, CA (US)

(21) Appl. No.: 13/047,762

(22) Filed: Mar. 14, 2011

Related U.S. Application Data
(60) Provisional application No. 61/314,740, filed on Mar. 17, 2010.

(51) Int. Cl. F16K 31/365; F17D 3/00; A01G 25/16; B05B 15/00

(52) U.S. Cl. 137/487; 137/8; 239/1; 239/542

(57) ABSTRACT

An system and method for flow control by controlling the output pressure for a liquid or a gas independently of the input pressure.

### CROSS REFERENCE TO RELATED APPLICATIONS

This application claims priority from provisional application No. 61/314,740.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE DESCRIBED EMBODIMENT OF THE PRESENT INVENTION

The described embodiment of the present invention relates generally to the field of flow controllers.

In many disciplines, a pressurized fluid or gas must be supplied in precise quantities. Typically, the flow of liquid, fluid or gas, or the quantity of liquid, fluid or gas supplied is controlled by regulating the flow of the fluid or gas. Fluid flow in the invention is independent of conduit size, supply pressure, and the like, and controlling the flow rate ensures that a precise quantity of the fluid is delivered where required. One example of a situation in which the quantity of a fluid supplied should be controlled is the delivery of fluids in an irrigation system.

Currently there is a great need for farmers, irrigation systems and process flow manufacturers to have an inexpensive, reliable way to have a steady pressure output coming from a variable pressure input.

The described embodiment of the present invention is of particular significance when used to control the flow of liquids or gases at relatively high flow rates and will be described in detail below in that context. But the described embodiment of the present invention may have application to other fluids or gases and to relatively small flow rates. The scope of the present invention should thus be determined with reference to the claims appended hereto and not the following detailed description.

A primary impediment to maintaining a constant flow of fluid in a system is that the pressure at which the fluid is supplied may be unknown or variable. In the context of an irrigation system, the source of the pressurized fluid may be a pump. The pressure of the fluid supplied by irrigation pumps can therefore fluctuate significantly.

The need thus exists for systems and methods for supplying gases and fluids, at a substantially constant flow rate when the input rate may be variable.

U.S. Pat. No. 4,015,626 issued to the present Applicant discloses a valve assembly for maintaining constant flow rates. This valve assembly comprises a housing that defines upstream and downstream chambers, a movable wall assembly arranged between these chambers, a spring located in the downstream chamber that acts on the movable wall, a bicycle valve located in the upstream chamber such that its control stem engages the movable wall, and coiled high resistance tubing connected between the chambers. Changes in the pressure in the downstream chamber allow the movable wall to move and operate the bicycle valve control stem to open or close the bicycle valve to control the flow of fluid flowing through the valve assembly. The spring may be adjusted to obtain different flow rates. The tubing functions as a pressure reducing restriction and to average the flow rate of fluid passing therethrough.

U.S. Pat. No. 6,026,849 also issued to the Applicant discloses a flow regulator having first and second stages of regulation. The first stage is a pressure regulation stage that maintains the pressure within an intermediate chamber within a predetermined range above the pressure in an outlet port. The second stage maintains the flow rate within a predetermined range about a target flow rate. Both stages sample the pressure in the outlet port and automatically adjust the flow of fluid to ensure that fluctuations in pressure at the inlet and outlet ports do not affect the flow rate. The flow rate is set and controlled by a piston and valve arrangement The pressure is regulated by a similar piston and valve arrangement. A flexible membrane is used to allow pressures in one chamber to be transferred into a control signal that operates a control valve in another chamber.

The valve assemblies disclosed in the '626 and '849 patents are optimized to regulate the flow of relatively small quantities of gasses and not relatively large quantities of liquids.

Current systems can only provide stable output pressures if the input pressures are within fairly narrow parameter changes.

### BRIEF SUMMARY OF THE INVENTION

One object of the described embodiment of the present invention is to allow flow control for liquids and gases irrespective of the input pressure of the liquid or gas.

Another object of the described embodiment of the present invention is to provide a better way of controlling liquid and gas flows over a wide pressure range.

Another object of the described embodiment of the present invention is to provide a less expensive article of manufacture to control liquid and gas flows which is less expensive to manufacture than current technology.

A further object of the described embodiment of the present invention is to save large amounts of water or other liquids in high volume operations such as field irrigation.

Other objects and advantages of the described embodiment of the present invention will become apparent from the following descriptions, taken in connection with the accompanying drawings, wherein, by way of illustration and example, one possible embodiment of the present invention is disclosed.

### BRIEF DESCRIPTION OF THE PREFERRED EMBODIMENTS

The drawings constitute a part of this specification and include exemplary embodiments to the described embodiment of the present invention, which may be embodied in various forms. It is to be understood that in some instances various aspects of the described embodiment of the present invention may be shown exaggerated or enlarged to facilitate an understanding of the invention.

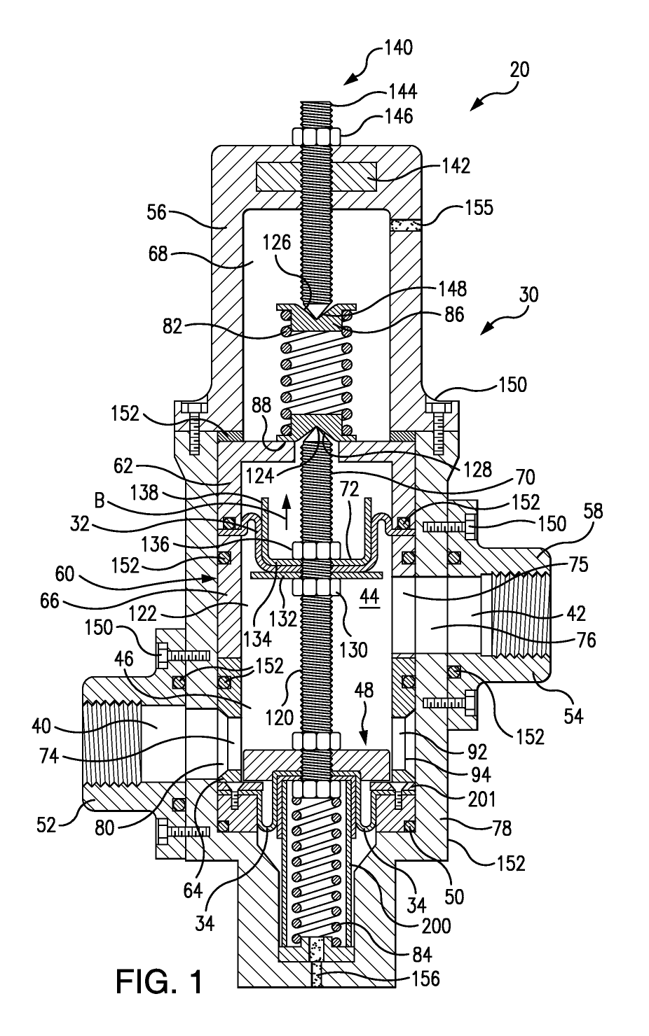

FIG. 1 is an elevation, cutaway view of an example flow control system of a described embodiment of the present invention in a first configuration which is open all the way;

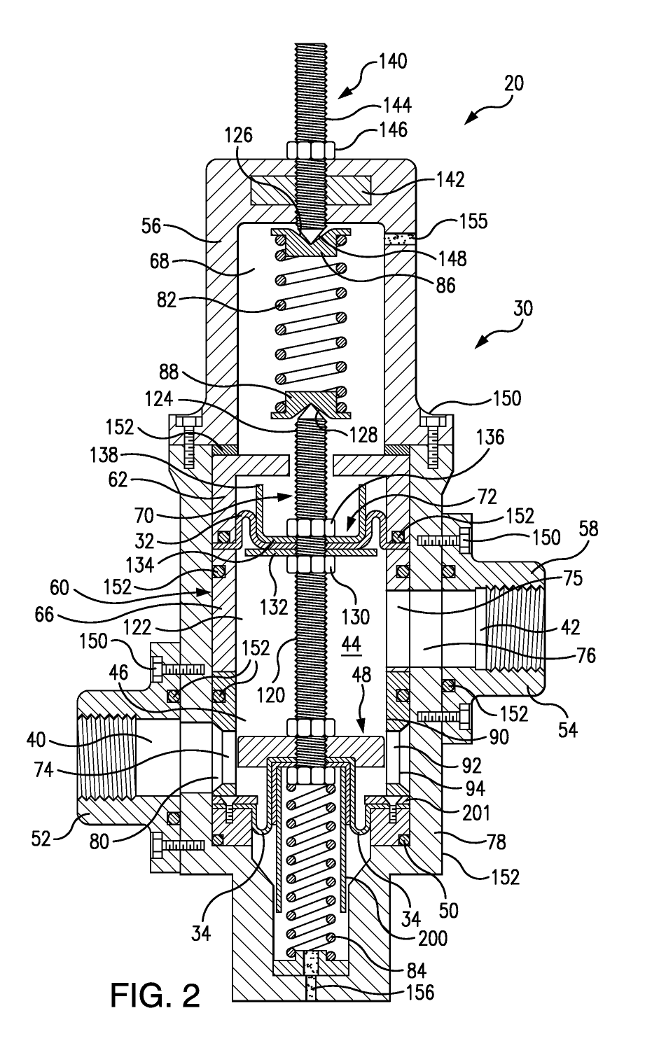

FIG. 2 is an elevation, cutaway view of the example flow control system of FIG. 1 in a second configuration when it is opened midway;

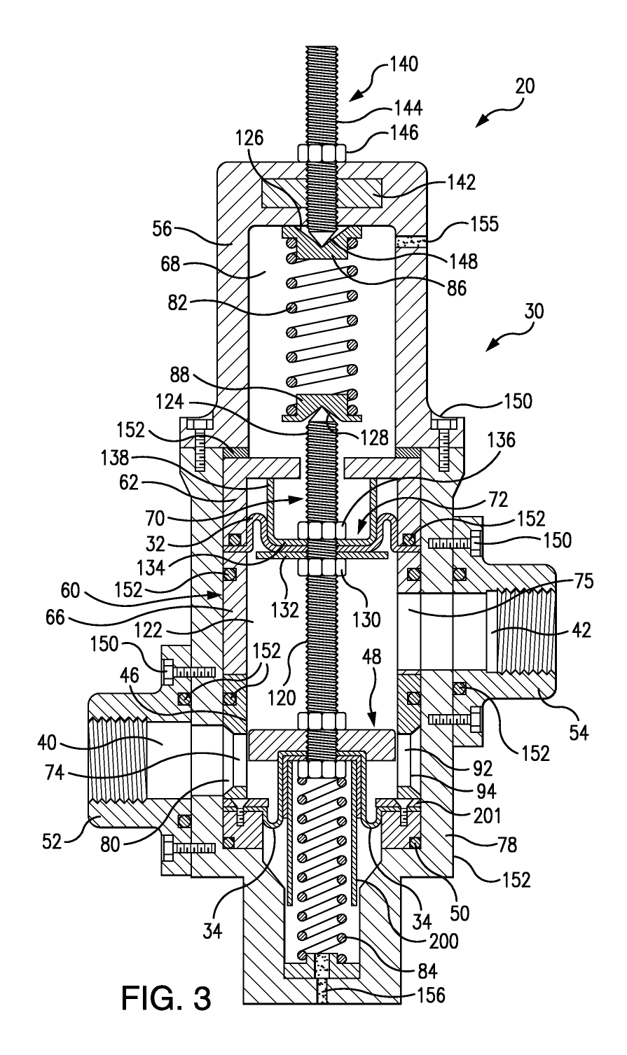

FIG. 3 is an elevation, cutaway view of the example flow control system of FIG. 1 in a third configuration when it is closed as far as it can be closed; and

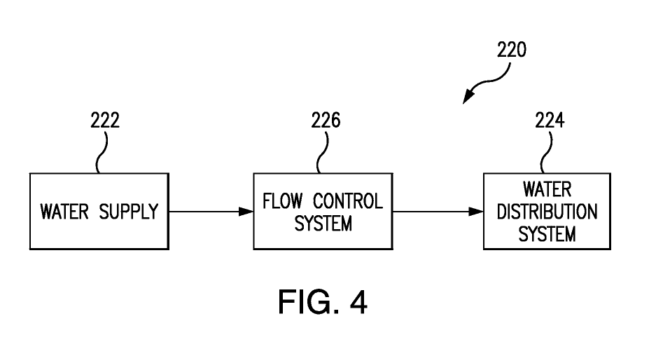

FIG. 4 is a block diagram illustrating an irrigation system incorporating a flow control system as depicted in FIGS. 1-3.

### DETAILED DESCRIPTION OF THE PREFERRED EMBODIMENTS

Detailed descriptions of described embodiment of the present invention are provided herein. It is to be understood, however, that the present described embodiment of the invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the described embodiment of the present invention, FIG. 1 shows a cross-sectional view of the invention, showing generally the hollow main housing, the hollow main housing forming a vertical circular opening through the center of the main housing, an input port connected opening into the hollow of the main housing a limited inlet opening between the input port and the hollow main housing, and an output port connected to the opening into the hollow of the main housing. A lesser volume piston adjacent to the limited inlet opening is positioned such that vertical movement of the lesser volume piston will increase or decrease the amount of the flow of fluid which can flow into the hollow main housing through the input opening. The lesser volume piston anchored to the top of a return spring and has a water tight rolling first diaphragm anchored at a vertical location between the constant pressure spring and the lesser volume piston. This rolling first diaphragm is connected to the interior of the hollow main housing around the entire circumference of the interior of the housing below the level of the lesser volume piston. An adjustable control spring connected to a similar rolling second diaphragm is at the opposite end and the interior of the hollow main housing. A this other end a variable pressure spring (control spring) attached to the top of the hollow main housing inside the vertical circular opening is attached to the bottom return spring so that the return force of the spring assists movement. This return force assists movement of the valve member in the first direction. The control spring engages the connecting member to resiliently oppose movement of the valve member in the first direction along the system axis. The position of the piston determines the amount of fluid which can be flowing through the controller at any particular moment of time. Changes in the input pressure move the piston so that the output pressure remains constant over a wide range of input pressures.

Non-comprehensive examples of additional possible embodiments could include:

a threaded adjustment screw or pin (hereafter “pin”) attached to the top of the upper second spring (“variable pressure spring” or “control” spring);

a pressure output adjustment knob on top of the threaded adjustment screw or pin;

a thread assembly in the top of the hollow main housing for a variable pressure adjustment screw threaded through the thread assembly;

a spring attachment means to connect the control and return springs;

a top assembly cap;

an Input connection fitting;

an input pressure gauge;

an output pressure gauge;

an output connection fitting;

an upper housing element;

a lower housing element with a piston sealing means to make the upper piston water-tight;

a piston sealing means to make the lower piston water-tight;

assembly screws;

washers;

a spring attachment means which is pivotable; and/or

a gasket on the washers.

a plurality of smaller springs connected by a connecting means to create one large spring for the top or bottom spring, and/or one could also use two small springs connected by a connecting means to create one large spring for the top or bottom spring.

Referring initially to FIG. 1 of the drawing, depicted therein is an example of a completely open flow controller 20 constructed in accordance with, and embodying the principals of the present invention. The flow controller 20 comprises a housing assembly 30, a first diaphragm 32, and a second diaphragm 34. The housing assembly 30 defines a first input housing port 40 and a second output housing port 42. The first diaphragm 32 and second diaphragm 34 are supported relative to the housing assembly 30 such that the housing assembly 30 and the first diaphragm 32 and the second diaphragm 34 define a main chamber 44. The first diaphragm 32 and the second diaphragm 34 are both vented to outside atmospheric pressure. The first diaphragm 32 is vented to outside atmospheric pressure through first filter vent 155. The second diaphragm 34 is vented to outside atmospheric pressure through a second filter vent 156. The operative part of the valve assembly is comprised of a piston 48, which in the preferred embodiment is composed of a strong metal such as brass. It creates a valve in conjunction with its movement across the first valve port 46. The piston 48 is disposed within the main chamber 44 such that the flow controller 20 defines a flow path that extends through the first housing port 40, the first valve port 46, the main chamber 44, the second valve port 76, and the second housing port 42. Fluid flowing along the flow path causes the piston 48 to move relative to the housing assembly 30 such that a cross-sectional area of a portion of the flow path is altered. In the preferred embodiment, a cylindrical enclosure 200 comprised of a brass tubing encircles the first spring 84 (lower spring or return spring) so that the return force assists movement of the piston 48. Also, the preferred embodiment has a gasket 201 comprised of stainless steel at the base of the piston 48.

More specifically, an inlet pressure of the fluid at the first housing port 40 will determine a position of the piston 48 relative to the opening 46 of the input housing port 40. When the inlet pressure is below a first pressure level, the piston 48 will be in a home position and fully opened as illustrated in FIG. 1 and the valve will be open all the way. When the inlet pressure is above a second pressure level, the piston 48 will be in an end or closed position as illustrated by FIG. 3. The input pressure level is always kept greater than the output pressure level. The output pressure is kept constant by the combined action of the first diaphragm 32 and second diaphragm 34 adjusted by the pressure of a second spring 82 (upper spring or control spring) and a first spring 84 (lower spring or return spring). The upper spring is 82 and the lower spring is 84. The spring pressure of the second spring 82 (upper spring) and the first spring 84 (lower spring) is adjusted by the adjustment screw or adjustment pin 144. When the inlet pressure is between the first lower and the second higher pressure levels, the piston 48 will be in an intermediate position between the home position and the end position as shown in FIG. 2, thereby keeping the output pressure constant.

An effective cross-sectional area of the flow path is defined by a spatial relationship between the housing assembly 30 and the piston 48. When the piston 48 is in the home position and fully open, the first valve port 46 is fully open as it faces the first main port 40 and the effective cross-sectional area of the flow path is at its greatest value. When the piston 48 is in the end position, none of the first valve port 46 is open as it faces the first main port 40 and the effective cross-sectional area of the flow path is at its smallest value. As shown in FIG. 2, when the piston 48 is between the home and end positions, a portion of the piston 48 faces the first main port 46, and the value of the effective cross-sectional area of the flow path is somewhere between the greatest value and the smallest value. The effect of the springs and the diaphragms working in concert is to alter the effective cross-sectional area of the flow path, and the volume of fluid allowed to flow along the flow path over time is increased or decreased thereby keeping the output pressure constant at the desired pressure.

Accordingly, even if the inlet pressure varies within a range of inlet pressures defined by the first lower and second upper pressure levels, the flow controller 20 can maintain a substantially constant volume of fluid flowing along the flow path. To be most effective, the input and output pressure should be at least 5 psi higher in the input pressure than the output pressure.

With the foregoing general understanding of the described embodiment of the present invention in mind, the details of operation and construction of the example flow controller 20 will now be described in further detail.

Referring back to FIG. 1 of the drawing, the example housing assembly 30 of the flow controller 20 comprises a main housing 52. In the preferred embodiment, “O” rings may be used to seal a housing made of multiple parts. An inlet member of the main housing 52, an outlet member of main housing 54, and a spring member of main housing 56 comprise the main body of the housing 30. The inlet member of main housing 52 and outlet member of main housing 54 are rigidly connected to the main housing 50 to allow external inlet and outlet conduits (not shown) to be connected to the first and second housing ports 40 and 42, respectively. The second spring member of main housing 56 is rigidly connected to the main housing 50.

The example flow controller 20 further comprises a sleeve 60 and a cap 62. The sleeve 60 comprises a first sleeve member 64 and a second sleeve member 66. The sleeve 60 is arranged within the main chamber 44, and the first diaphragm 32 is supported by the sleeve 60 and the cap 62 within the main chamber 44. The second spring member of main housing 56 supports the cap 62 such that a spring chamber 68 is defined between the cap 62 and the second spring housing 56. The second spring member of main housing 56 further holds the cap 62 against the first diaphragm 32, the first diaphragm 32 against the sleeve 60, and the sleeve 60 against the main housing 50.

A connecting member 70 extends between the piston 48 and the first diaphragm 32 and the second diaphragm 34. As shown by a comparison of FIGS. 1, 2, and 3, the connecting member 70 rigidly connects the piston 48 and the first diaphragm 32 such that the piston 48 and the traveling portion 72 of the first diaphragm 32 and the second diaphragm 34 move together.

The sleeve 60 defines a first sleeve port 74, a second sleeve port 75, and an outer surface 78. As shown in FIG. 1, a channel 80 is formed in the outer surface 78 of the sleeve 60. The channel 80 is substantially aligned with the first main port 40. The valve members defined by a first valve port and a second valve port, are arranged within the main chamber such that a flow path extends through the first housing port, the first valve port, the first sleeve port, the second valve port, and the second housing port, and the second sleeve port, causing fluid to flow along the flow path such that the fluid causes the

valve member to move relative to the sleeve to alter a cross-sectional area of a portion of the flow path

FIG. 1 further illustrates that the example flow controller 20 comprises an upper second spring 82 and a lower first spring 84. The upper second spring 82 (control spring) is arranged within the spring chamber 68 and applies a control force to the connecting member 70 and thus to the traveling portion 72 of the first diaphragm 32 and to the piston 48. The control force opposes movement of the piston 48 in a first direction along a system axis B defined by the housing assembly 30. The lower first spring 84 is arranged to apply a return force to the piston 48 so that the return force assists movement of the piston 48 in the first direction along the system axis B.

The upper second spring 82 is supported under compression between a first valve seat member 86 and a second valve seat member 88. The first valve seat member 86 is supported by the second spring member of main housing 56. The second valve seat member 88 engages the connecting member 70. A position of the first valve seat member 86 relative to the second spring member of main housing 56 is adjustable to allow a bias force to be applied to the upper second spring 82 (control spring). The bias force allows the compression on the upper second spring 82 to be adjusted.

As described above, the effective cross-sectional area of the flow path is smallest when the piston 48 is in the end (closed) position as shown in FIG. 3. In particular, the effective cross-sectional area of the flow path is defined by the dimensions of the interstitial space 94. The interstitial space 94 thus always allows a small amount of fluid flow between the first sleeve port 74 and the first valve port 46, even when the piston 48 is in the end position. The example flow controller 20 thus never completely shuts off the flow of fluid between the first housing port 40 and the second housing port 42.

The first diaphragm 32 is a flexible, fluid impermeable sheet. A perimeter edge of the first diaphragm 32 is rigidly held between the sleeve 60 and the cap 62. The traveling portion 72 of the first diaphragm 32 is rigidly connected to the connecting member 70. Accordingly, movement of the traveling portion 72 of the first diaphragm 32 is transferred to the connecting member 70. During use of the example flow controller 20, the inlet member of main housing 52 is connected to an inlet conduit (not shown) that is in turn connected to a source of unregulated, pressurized liquid such as an irrigation pump. The outlet member of main housing 54 is connected to an outlet conduit that is in turn connected to a destination of regulated liquid, such as a sprinkler assembly.

The channel 80 extends completely around the first sleeve member 64 and the openings 92. Accordingly, fluid flowing through these openings 92 into the interstitial space 94 flows generally radially inwardly toward the system axis B. The fluid in the interstitial space 94 thus does not act asymmetrically on the second diaphragm 34 in a manner that would force the second diaphragm 34 against the sleeve 60 and thereby inhibit movement of the second diaphragm 34 along the system axis A.

Pressurized liquid within the main chamber 44 acts on the first diaphragm 32. Above the first pressure level, the force applied by the pressurized liquid on the first diaphragm 32 will displace the traveling portion 72 of the first diaphragm 32 in a first direction indicated by Arrow B in FIG. 1. Because the traveling portion 72 is rigidly connected to the connecting member 70 and the connecting member 70 is rigidly connected to the piston 48, the piston 48 is also displaced in the First Direction B. The second diaphragm 34 does not impede the movement of the piston 48, because the effective area of the second first 32 is smaller than the effective area of the second diaphragm 34.

In the preferred embodiment, the ratio of the effective area is 1.05 to 0.37 between the first diaphragm 32 and the second diaphragm 34.

With appropriate selection of the springs 82 and 84 and the bias force applied to the upper second spring 82 (control spring), the piston 48 will reciprocate along the system axis B as necessary to adjust for fluctuations in the inlet pressure. The flow rate of fluid exiting the main chamber 44 through the second sleeve port 75 and the second housing port 42 will thus be maintained at a substantially constant level set by the values of the springs 82 and 84 and magnitude of the bias force.

The flow controller 20 may also be constructed in one type of embodiment without the control spring 82 and the bias spring 84. In this case, the first diaphragm 32 itself must be constructed to resiliently oppose pressure established by liquid within the main chamber 44. For the pressures expected in liquid systems such as an irrigation system, however, use of the springs 82 and 84 greatly simplifies the fabrication of the first diaphragm 32 and second diaphragm 34.

The first diaphragm 32 is rigidly connected to the connecting member 70 as follows. In the preferred embodiment example shown, connecting member 70 is a threaded rod having a first end 120 secured to a cross-brace assembly 132 and a second end 124. Depressions 126 and 128 are formed in the first and second valve seat members 86 and 88, respectively. The second end 124 of the connecting member 70 is configured to engage the depression 128 formed in the second valve seat member 88.

A first nut 130 is threaded onto the connecting member 70. The threaded member 70 is then inserted through a first diaphragm plate 132 (cross-brace assembly), the traveling portion 72 of the first diaphragm 32, and through a second first diaphragm plate 134. A second nut 136 is then threaded onto the connecting member 70 and tightened such that the traveling portion 72 of the first diaphragm 32 is rigidly clamped between the first diaphragm plates 132 and 134.

A stop flange 138 extends from the second first diaphragm plate 134. As shown in FIG. 3, when the Piston 48 is in the end position, the stop flange 138 engages the cap 62 to prevent further movement of the first diaphragm 32. The stop flange 138 thus prevents damage to the first diaphragm 34 under high pressures above the second pressure level. FIG. 1 further illustrates that the example flow controller 20 further comprises a bias force adjustment assembly 140 comprising an insert 142, an adjustment screw or pin 144, and a lock nut 146. To reduce costs, the spring housing 56 and other components of the controller may be made of plastic or other suitable material. The insert 142 is embedded within the second spring member of main housing 56 to provide an internal threaded surface for engaging the adjustment screw or pin 144.

With the adjustment screw or pin 144 (“pin” is defined as either a screw or a pin for purposes of the claims) extending through the second spring member of main housing 56 and threadingly engaged with the insert 142, axial rotation of the adjustment pin 144 displaces the pin 144 along a longitudinal axis thereof. A first end 148 of the adjustment pin 144 engages the depression 126 formed in the first valve seat member 86.

As mentioned above, the housing assembly 30 is typically formed by a number of separate components. These components are secured to each other using a plurality of bolts 150. Seals 152 in the form of conventional a-rings, gaskets, or the like are used where necessary to establish a fluid-tight fluid path.

Referring now to FIG. 4 of the drawing, represented therein is an example irrigation system 220 comprising a water supply 222, a water distribution system 224, and a flow control system 226. The irrigation system 220 is designed to operate within predetermined parameters to distribute water to a particular area to be irrigated.

The water supply 222 is or may be conventional and provides a source of pressurized water suitable for irrigation purposes. The parameters of the pressurized water supplied by the water supply 222 need not be constant or known in advance; to the contrary, the water pressure can be within an operating range defined by a predetermined minimum determined by the requirements of the water distribution system 224 and a predetermined maximum determined by the components of the flow control system 226. Often, the water supply 222 takes the form of a pump operatively connected to a reservoir.

The water distribution system 224 is or may be conventional and typically comprises a set of components, such as conduits, sprinkler assemblies, and/or drip assemblies, configured for the particular area to be irrigated. The water distribution system 224 is typically configured to distribute a predetermined quantity of water during a predetermined time period. The predetermined quantity of water and the predetermined time period will be determined with reference to the characteristics of the area to be irrigated and environmental factors such as heat and/or humidity.

The example flow control system 226 comprises the flow controller described above. The first housing port 40 is operatively connected to the water supply 222, while the second housing port 42 is operatively connected to the water distribution system 224. The flow controller 20 is configured to allow the flow of water from the water supply 222 to the water distribution system 224 to be regulated. Regulation of the flow of water from water supply 222 to the water distribution system 224 allows the quantity of water distributed by the water distribution system 224 over the predetermined time period to be approximately equal to the predetermined quantity of water desired. The flow controller 20 thus helps to ensure that the irrigation system 220 operates within the predetermined operating parameters.

The flow control system 226 may in one embodiment comprise only the flow controller 20 as described above but may also in other embodiments be configured to include additional components such as an outer housing, pipe fittings, control valves, and the like. The details of the flow control system 226 will thus typically be determined by the details of the water supply 222 and the water distribution system 224.

The described embodiment of the present invention may be embodied in forms other than those described above. The scope of the described embodiment of the present invention should thus be determined by the claims appended hereto and not the foregoing detailed description of the invention.

While the described embodiment of the present invention has been described in connection with a preferred embodiment, it is not intended to limit the scope of the invention to the particular form set forth, but on the contrary, it is intended to cover such alternatives, modifications, and equivalents as may be included within the spirit and scope of the described embodiment of the present invention as defined by the appended claims.

Insofar as the description above and the accompanying drawings disclose an additional subject matter that is not within the scope of the single claim below, the inventions are not dedicated to the public and the right to file one or more applications to claim such additional inventions is reserved.

I claim:

1. A system for regulating the flow of fluid comprising:
a housing assembly defining a first input housing port and a second output housing port;
a first diaphragm and a second diaphragm, wherein the first diaphragm and the second diaphragm are supported relative to the housing assembly such that the housing assembly and the first diaphragm and the second diaphragm define a main chamber;
a plurality of vents to vent the first diaphragm and the second diaphragm to outside atmospheric pressure;
a valve member defining a first valve port, where the valve member is arranged within the main chamber;
a piston;
the piston disposed within the main chamber such that it creates a valve in conjunction with its movement across the first valve port;
a valve member defining a second valve port, where the valve member is arranged within the main chamber;
the second valve port and the second housing port defining a flow path that extends through the first housing port, the first valve port, the main chamber, the second valve port, and the second housing port, wherein fluid flowing along the flow path causes the valve member to move relative to the main housing to alter a cross-sectional area of a portion of the flow path; and
movement of the piston by the movement of the first and second diaphragm relative to the valve member adjusts a volume of fluid flowing along the flow path.

2. A system as recited in claim 1, further comprising:
a control spring arranged to apply a control force to the first diaphragm, where the control force opposes movement of the piston in a first direction.

3. A system as recited in claim 2, further comprising a spring housing, where:
the spring housing is coupled to the main housing to define a spring chamber; and
a control spring is arranged within the spring chamber.

4. A system as recited in claim 2, further comprising a return spring arranged to apply a return force to the piston, where the return force assists movement of the piston to return from the first direction.

5. A system as recited in claim 2, further comprising a spring adjustment system for applying a bias force to the control spring.

6. A system as recited in claim 5, in which the spring adjustment system comprises an adjustment pin, where the adjustment pin is displaced to apply a preload force on the control spring.

7. A system as recited in claim 1, further comprising a return spring arranged to apply a return force to the piston, where the return force assists movement of the piston to return from the first direction.

8. A system as recited in claim 1, further comprising a sleeve defining a first sleeve port and a second sleeve port; wherein:
the sleeve is arranged within the main chamber; and
the sleeve defines a plurality of sleeve openings, where the sleeve openings define the first sleeve port.

9. A system as recited in claim 1, wherein:
a first sleeve port;
a second sleeve port; and
a sleeve outer surface form a sleeve channel in the sleeve outer surface such that at least a portion of the fluid flowing to the first sleeve port flows through the sleeve channel.

10. A system as recited in claim 1, further comprising a sleeve defining a first sleeve port and a second sleeve port; wherein:
the sleeve defines a sleeve outer surface; and
a sleeve channel is formed in the sleeve outer surface, wherein
at least a portion of the fluid flows from the first housing port through the sleeve channel.

11. A system as recited in claim 1 further comprising a stop flange, wherein:
a first diaphragm, a first diaphragm plate, and the stop flange are adjustably supported relative to the valve member; and
adjustment of the first diaphragm plate, the first diaphragm, and the stop flange relative to the valve member adjust a volume of fluid flowing along the flow path.

12. A system as recited in claim 1 further comprising a
a cap member supported by the main housing, where the cap member supports the first diaphragm relative to the main housing such that the main housing and the first diaphragm define a main chamber and a cap chamber;
a spring housing attached to the main housing such that the cap member and the spring housing define a spring chamber;
a control spring arranged within the spring chamber; and
a connecting member operatively connected to the valve member and the diaphragm member such that movement of the valve member is transferred to the diaphragm member, where the connecting member operatively engages the control spring;
the control spring engages the connecting member to resiliently oppose movement of the piston to return from the first direction along the system axis; and
adjustment of the first diaphragm plate and the second diaphragm relative to the piston adjusts a volume of fluid flowing along the flow path.

13. A system as recited in claim 12, further comprising a return spring arranged to apply a return force to the piston, where the return force assists movement of the piston to return from the first direction along the system axis.

14. A system as recited in claim 13, further comprising a spring adjustment system for applying a bias force to the control spring.

15. A system as recited in claim 14, in which the spring adjustment system comprises an adjustment pin, where the adjustment pin is displaced relative to the valve housing to apply a preload force on the control spring.

16. A system as recited in claim 12, further comprising a sleeve defining a first sleeve port and a second sleeve port, wherein:
liquid flows from the first housing port into the first sleeve port and from the second sleeve port to the second valve port; and
the first sleeve port is defined by a plurality of sleeve openings in the sleeve.

17. A system as recited in claim 12, further comprising a sleeve defining a first sleeve port, a second sleeve port, and a sleeve outer surface, wherein:
liquid flows from the first housing port into the first sleeve port and from the second sleeve port to the second valve port; and
a sleeve channel is formed in the sleeve outer surface, wherein at least a portion of the fluid flowing to the first sleeve port flows through the sleeve channel.

18. A method of regulating the flow of liquid comprising the steps of: providing a main housing defining a first housing port and a second housing port;
supporting a flow restrictor relative to the main housing to define a cross-sectional area of the second housing port;
supporting a first diaphragm and a second diaphragm, wherein the first diaphragm and the second diaphragm are supported relative to the housing assembly such that the housing assembly and the first diaphragm and the second diaphragm define a main chamber; and
providing a first diaphragm plate;
providing a valve member defining a first valve port and a second valve port;
providing a first sleeve and a second sleeve, and a first sleeve port and a second sleeve port;
arranging a piston within the main chamber such that a flow path extends through the first housing port, the first valve port, the first sleeve port, the second valve port, the second housing port, and the second sleeve port;
causing fluid to flow along the flow path such that the fluid causes the piston to move relative to the first sleeve port to alter a cross-sectional area of a portion of the flow path; and
adjusting a location of the first diaphragm plate relative to the piston to adjust a volume of fluid flowing along the flow path.

19. A method as recited in claim 18, further comprising the step of arranging a control spring to apply a control force to the first diaphragm such that the control force opposes movement of the piston in a first direction.

20. A method as recited in claim 18, further comprising the step of arranging a return spring to apply a return force to the valve member such that the return force assists movement of the valve member to return from the first direction.

21. An irrigation system, comprising:
a water supply for supplying pressurized water;
a water distribution system adapted to distribute water to a particular area to be irrigated; and
a flow control system, where the flow control system comprises a flow controller comprising:
a main housing assembly defining a first housing port operatively connected to the water supply and a second housing port operatively connected to the water distribution system;
a first diaphragm and a second diaphragm, wherein the first diaphragm and the second diaphragm are supported relative to the housing assembly such that the housing assembly and the first diaphragm and the second diaphragm define a main chamber;
a valve member defining a first valve port and a second valve port, where the valve member is arranged within the main chamber;
a first diaphragm plate supported by the valve member where the diaphragm plate and a second portion of the diaphragm are adjustably supported relative to the valve member;
a flow restrictor supported relative to the main housing to define a cross-sectional area of the second housing port; where
a flow path extends through the first housing port, the first valve port, the second valve port, and the second housing port; and
water flowing along the flow path causes the valve member to move relative to the main housing to alter a cross-sectional area of a portion of the flow path: and adjustment of the diaphragm plate and the second portion of the diaphragm relative to the valve member adjusts a volume of fluid flowing along the flow path.

22. A method of distributing water to a particular area to be irrigated comprising the steps of:
providing a main housing defining a first housing port and a second housing port;
supporting a flow restrictor relative to the main housing to define a cross-sectional area of the second housing port;
a first diaphragm and a second diaphragm, wherein the first diaphragm and the second diaphragm are supported relative to the housing assembly such that the housing assembly and the first diaphragm and the second diaphragm define a main chamber; and
providing a piston;
providing a first diaphragm plate;
providing a valve member defining a first valve port and a second valve port;
arranging the valve member within the main chamber such that a flow path extends through the first housing port, the first valve port, the second valve port, and the second housing port; and
operatively connecting the first housing port to a water supply to cause water to flow along the flow path such that the water causes the piston to move to alter a cross-sectional area of a portion of the flow path; and
operatively connecting the second housing port to a water distribution system configured to distribute water to the particular area to be irrigated; and
adjusting a location of the first diaphragm plate relative to the valve member to adjust a volume of fluid flowing along the flow path.
